(19) United States
(12) Patent Application Publication
(10) Pub. No.: US 2008/0060822 A1
(43) Pub. Date: Mar. 13, 2008

(54) VEHICLE MOUNTED FIRE AND RESCUE BOOM

(75) Inventors: James A. Salmi, Lititz, PA (US); Reid L. Wissler, Brownstown, PA (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: SPARTAN MOTORS, INC., Charlotte, MI (US)

(21) Appl. No.: 11/854,572

(22) Filed: Sep. 13, 2007

Related U.S. Application Data
(60) Provisional application No. 60/825,483, filed on Sep. 13, 2006.

(51) Int. Cl. A62C 27/00

(52) U.S. Cl. 169/24

(57) ABSTRACT

A boom adapted for use on a fire fighting vehicle or a rescue vehicle includes an elongated boom having an outer housing. A second, inner body, forming an enclosed channel for water flow is contained within the outer housing. A plurality of connecting fins (for example, four) connect the interior of the outer housing with the exterior of the inner body, the space between the exterior of the inner body and the interior of the outer housing being divided by the fins into several generally independent channels within which elongated electrical control line members and hydraulic lines can be contained and protected. The boom may end at a workhead. The workhead may include a water monitor, water handline connections, a bank of lights, hydraulic fittings, pneumatic fittings, a lifting point and/or other emergency or rescue equipment. The boom may be pivotally mounted to a fire fighting vehicle such as a pumper engine, for example, on a turntable. The boom may include an extendible lift arm assembly and an intermediate lifting system.

### BACKGROUND OF THE INVENTION

The present invention relates to vehicle mounted booms for fire and rescue equipment. More specifically, the invention relates to positionable waterways and other equipment support devices or booms for fire fighting water pumper engines or other fire and rescue apparatus.

Fire fighting equipment is often provided with a waterway to provide fire fighters with a mechanism for supplying a stream of water or other fluid fire extinguishing chemical to the site of a fire. In many situations, it is desirable to provide an elevated fluid stream or to provide the stream from an extended distance. To meet this need, waterways are often incorporated into a boom that is mounted to a fire fighting vehicle. The boom may be mounted near the rear of a fire fighting vehicle on a mechanism, such as a turntable, that permits the elevation and rotational position of the boom to be controlled. To provide extended reach, conventional waterway booms include a complex telescoping or folding structure. In many applications, the waterway is used in conjunction with an aerial ladder. The waterway may be provided with remote control devices which permit fire fighters to control the discharge of fluid onto a fire while maintaining a safe distance from the fire.

Conventional booms suffer from a number of disadvantages—perhaps the most important of which is cost. The use of complex telescoping and folding booms results in highly complex and expensive apparatus. Each point of independent motion in the boom, whether it is folding or telescopic articulation, requires corresponding motion in the waterway. These points of articulation typically require special hardware that is not only expensive to purchase or build, but also expensive to install. As the length of the boom increases, the engineering challenges associated with support and control of the boom increase dramatically. These engineering challenges further increase the cost and weight of the apparatus. A conventional fire fighting engine with an elevated water stream can be too expensive to fall within the budget constraints of many small to mid-size fire department and municipalities. In fact, sophisticated aerial ladder trucks can be so expensive that they that can pose a financial burden even for larger fire departments and municipalities.

In fire-fighting and rescue applications it is often desirable to have an elevated light tower that is capable of providing bright illumination over a wide area. Like waterways, light towers are available with telescoping booms. For example, fire and rescue vehicles are available with a centrally located light tower that can be raised telescopically to provide an overhead light source. Light towers further increase the financial burden on fire departments and municipalities.

In addition to water and lighting, fire and rescue operations often utilize a variety of additional fire and rescue accessories. For example, winches and other lifting accessories are useful in many situations. As another example, hydraulic extrication tools are often used to free a trapped victim or to form an access opening in a structure. A host of other hydraulic, electric and air powered tools are also used in fire and rescue operations.

### SUMMARY OF THE INVENTION

The present invention provides an improved boom that incorporates not only a waterway, but also parallel protective channels for related apparatus, including service lines, such as hydraulic hoses and electrical lines. In one embodiment, the boom includes a single-piece, elongated member that includes the waterway channel and also the separate parallel channels adapted to provide protective raceways for the other apparatus such as hydraulic lines, pneumatic lines and electrical wires or cords. In one embodiment, the boom may be separately mounted on an engine or other vehicle. The boom may terminate at a workhead that is fitted with a water monitor.

In one embodiment, the boom is a one piece extruded construction within which there is an enclosed waterway channel and at least one additional channel for accessories to be routed to the free end of the boom. The waterway may be positioned centrally of the extrusion, the outer structure of which forms a housing within which one or more additional channels are contained.

In accordance with one embodiment, the boom is formed of a single length of extruded aluminum. The extrusion includes the outer shell or housing within which a second, inner enclosed channel for water flow is contained. In this embodiment, the waterflow channel may be fixed at the center of the outer housing by a plurality of connecting extruded radially extending walls that connect the interior of the outer housing with the exterior of the central channel body that forms the waterflow channel. The housing, inner channel body and the radial walls may all be formed of a single integral extruded piece. The space between the exterior of the inner body and the interior of the outer housing may be divided by the radial walls into several channels within which elongated electrical control line members, hydraulic lines, pneumatic lines and other accessories to be routed to the working end of the boom can be contained and protected.

The boom may be connected to a fire or rescue vehicle, such as a water pumper engine. The boom may be mounted at the front of the body behind the cab and be directed rearward toward the back of the vehicle. The position and orientation of the boom may, however, vary. For example, the boom may alternatively be mounted at the rear corner of the vehicle and directed toward the front. The boom may be hydraulically movable upward, downward and laterally and may be powered by power takeoff (PTO) provided from the firefighting vehicles' transmission system. Usually, the boom is supplied with water pumped by a water pump on board the vehicle, but it can also be supplied with water from another source, such as a fire hydrant. To provide rotational movement, the boom may be mounted on a rotating pedestal at its base to provide a pivoting connection point to the engine body.

Still further aspects of the invention include the provision of controls on the pumper engine usually provided at the base of the boom. Such controls can provide for proportional hydraulic boom controllers which enable raising, lowering and both clockwise and counterclockwise continuous rotation of the boom. Switches and other controls may also be provided for directional control of water discharge up or down, right or left, stream or fog and auto stow. Other indicators and switches can be provided for control of illumination, boom/cradle alignment and waterway flow meter.

In accordance with other aspects of the invention, the boom is provided with lifting attachment points for firefighting rescue operations. Further, a winch or other lifting device may be provided. The winch may be mounted at the free end of the boom to provide direct lifting capabilities. Alternatively, the winch may be mounted at the base of the boom or elsewhere on the vehicle and include a cable that passes through a pulley at the free end of the boom.

The boom may include a workhead having a variety of other optional features such as lighting devices, power receptacles for electric tools, hydraulic fittings for hydraulic rescue tools, pneumatic fittings for pneumatic tools and mounting brackets for stokes baskets and other accessories. The workhead may also include swiveling handline hose connections to supplement the capabilities of the water monitor.

The boom may also incorporate antennae, network relays, wireless routers, communications relays, transceivers and other communications equipment for a variety of communications systems, such as ground-based satellite communications, trunk radio, base stations and various forms of local network communications. These systems may provide secure and non-secure voice, data and video communications and data collection. For example, the boom may incorporate a transceiver for providing operational capabilities for a local command center.

As noted, in accordance with an embodiment of the invention, the waterway boom is formed of a single piece extruded aluminum member. The extruded aluminum may be formed of an outer cylindrical body within which a tubular body of smaller diameter is concentrically contained and which forms the waterway channel. The plurality of radially extending walls serve to fix the position of the tubular waterway channel as well as to divide the annular space between the outer cylindrical housing and the waterway channel into a plurality and usually three or four independent channels within which other elongated materials, such as hydraulic pipes or hoses electrical conduits are contained and protected. The number of channels provided is determined by the number of walls used in the extrusion. Although the walls may be positioned radially with respect to the waterway channel, other configurations could be employed. For example, the walls could be tangential relative to the inner tubular body.

The use of an annular boom construction in some embodiments provides those embodiments with improved structural characteristics. Among other things, the annular design provides a symmetric construction that enjoys uniform rigidity and uniform structural response to directional loads, and provides a very weight-efficient structure. When used, radially symmetric walls for interconnecting the inner and outer annular walls of the boom will further contribute to the overall symmetry and structural integrity of the boom. Additionally, the invention incorporates a wide variety of firefighting functionalities in an integrated, cost effective manner which requires limited manpower.

In one embodiment, the boom may include an extendible lift arm assembly. The lift arm assembly may include a telescoping boom arm that terminates in a lifting head. The lifting head may define an eye that can function as a lift point. For example, a clevis may be used to secure a lifting connection, such as a pulley, to the lift head. The extendible lift arm assembly allows the lifting point to better positioned above an object to be raised. The extendible lift arm also permits the lifting point to be moved without the need to move the truck

In one embodiment, the boom includes an intermediate lifting system to assist in lifting fire and rescue equipment from the top of the truck to the ground and vice versa. The intermediate lifting system may include a winch and a plurality a lift points disposed along the length of the boom. The winch and lift points are aligned so that the winch can be used in connection with any one of the lift points to provide interior lift points at various positions along the length of the boom. In one embodiment, the intermediate lifting system includes a lift beam extending along a portion of the bottom of the boom. The lift beam may define a plurality of spaced lifting points. The winch and lift beam may be mounted in alignment on the bottom surface of the boom. The intermediate lifting system provides a simple and effective mechanism for raising and lowering equipment from the truck to the ground. This minimizes climbing and reduces operations on the top of the truck.

In one embodiment, the intermediate lifting system may include a track and trolley system. The track and trolley system may include a track mounted to the undersurface of the boom and a trolley movably mounted on the track. The trolley may include a winch or other lifting device for raising/lower items to be carried by the track and trolley system. The trolley may be manually movable along the track or it may include a drive system, such as an onboard motor and drive wheel assembly.

These and other objects, advantages, and features of the invention will be readily understood and appreciated by reference to the detailed description of the current embodiment and the drawings.

### BRIEF DESCRIPTION OF THE DRAWINGS

FIG. 1 is a perspective view of a fire engine incorporating a boom in accordance with an embodiment of the present invention.

FIG. 2 is a perspective view of the fire engine with the boom in an operating position.

FIG. 3 is a rear perspective view a portion of the fire engine.

FIG. 4 is a perspective view of a portion of the fire engine with the cab and other portions removed.

FIG. 5 is a perspective view of a portion of the fire engine showing the pedestal, swivel and portions of the boom.

FIG. 6 is a perspective view of a portion of the boom and pedestal with portions cut away to show the interior of the boom.

FIG. 7 is a top perspective view of the boom workhead with portions removed.

FIG. 8 is a bottom perspective view of the boom workhead with portions removed.

FIG. 9A is a side elevational view of a portion of the boom with an extendible lift arm assembly.

FIG. 9B is a side elevational view similar to FIG. 9A showing the extendible lift arm assembly with the extendible boom arm in the extended position.

FIG. 9C is a cross-sectional view of the extendible lift arm assembly taken along line 9C-9C of FIG. 9A

FIG. 10 is a side elevational view of a portion of the boom showing an intermediate lifting system.

FIG. 11 is a side elevational view of a portion of the boom showing an alternative intermediate lifting system.

### DESCRIPTION OF A CURRENT EMBODIMENT

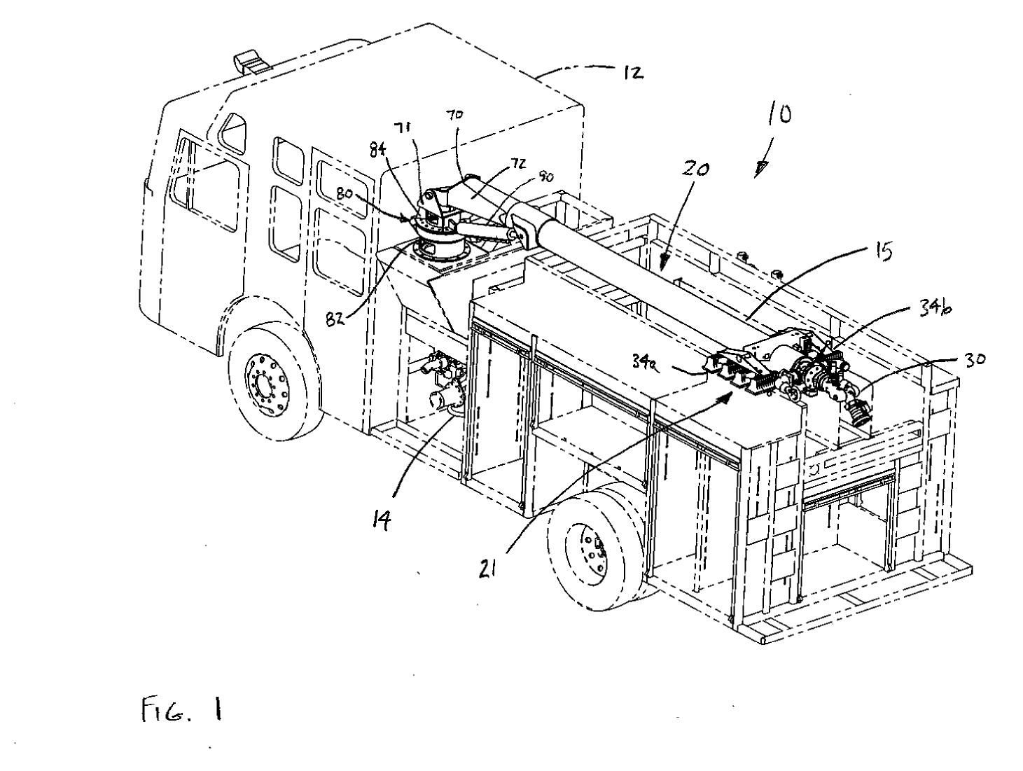

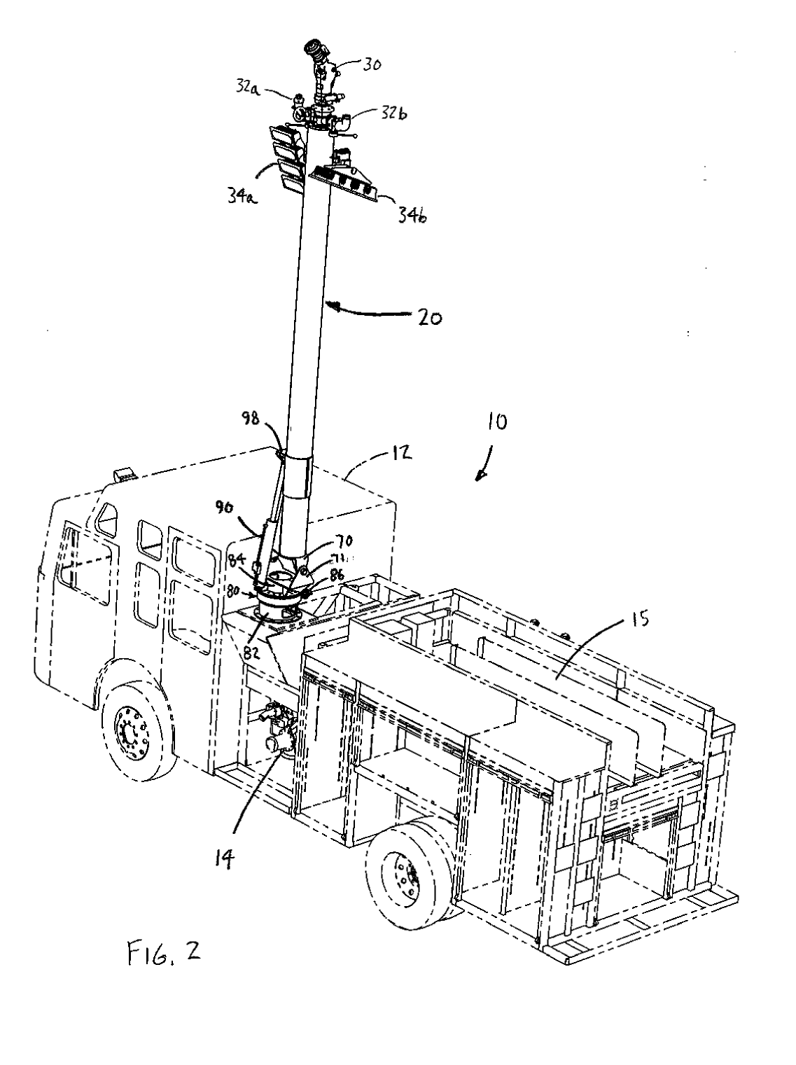

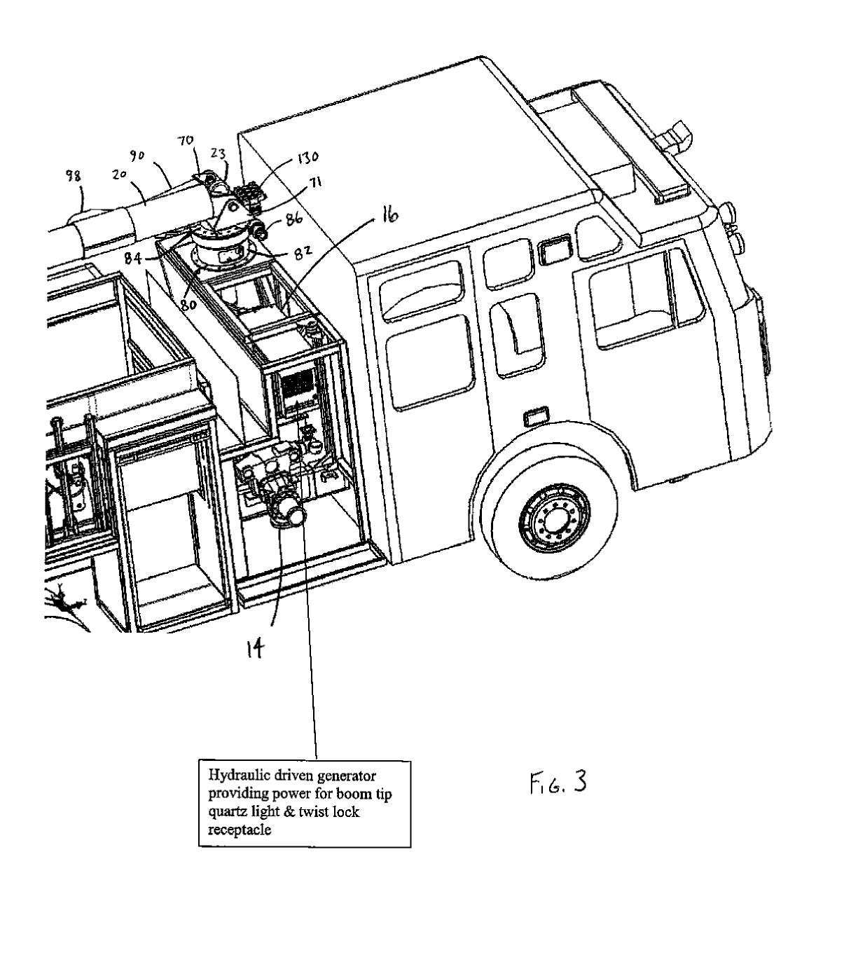

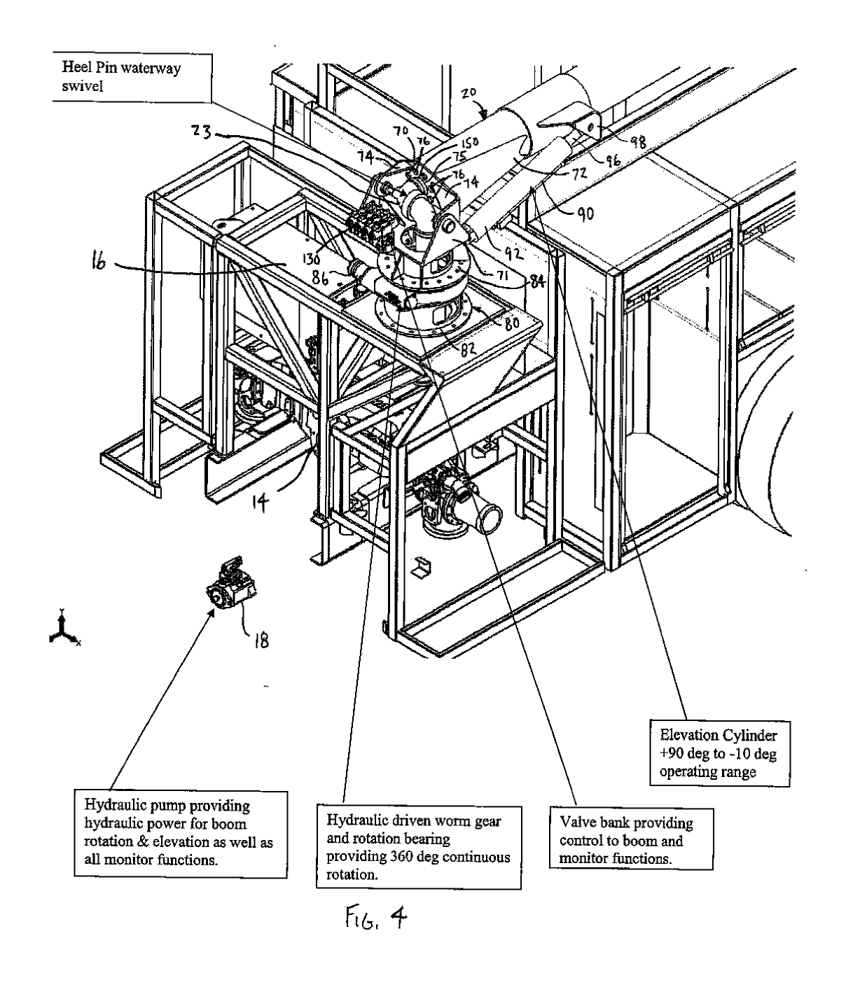

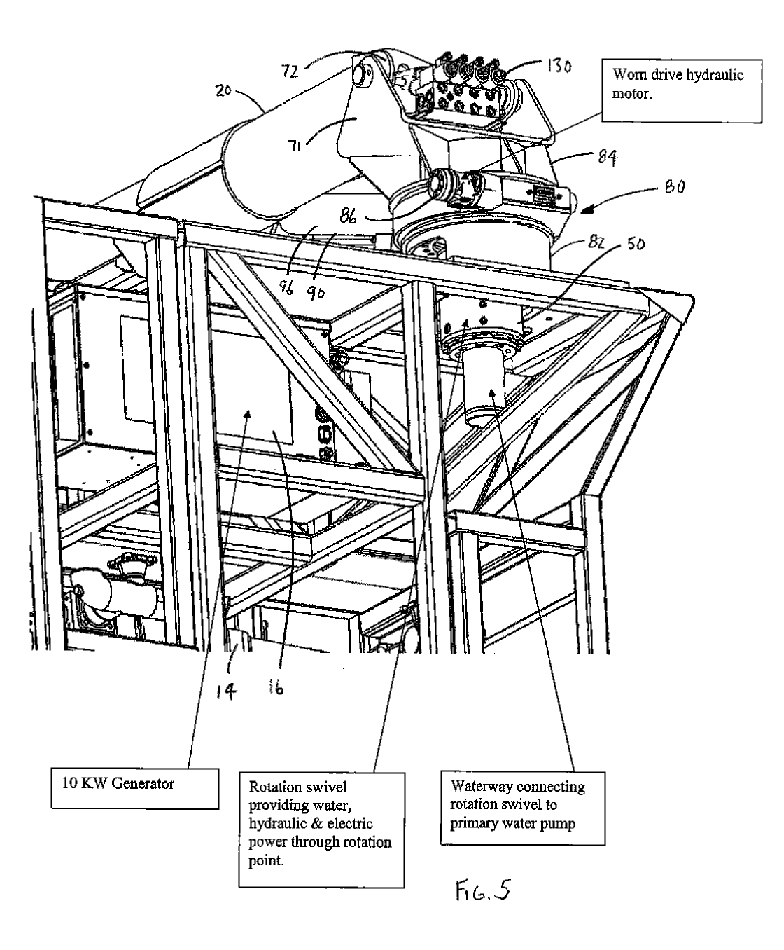

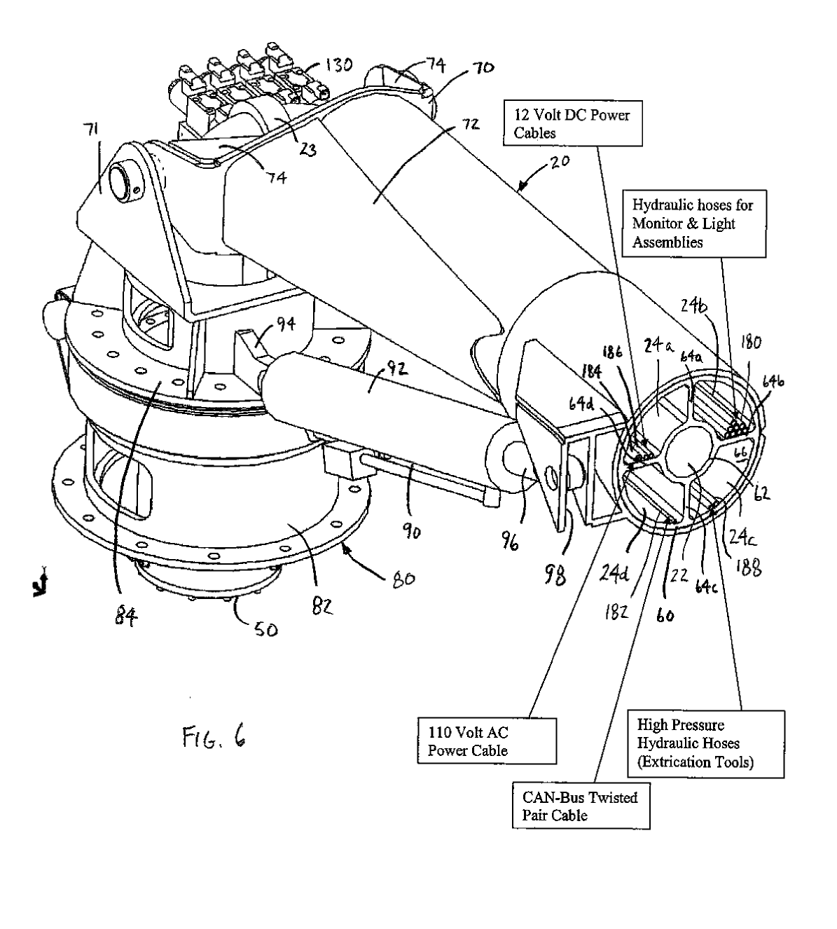

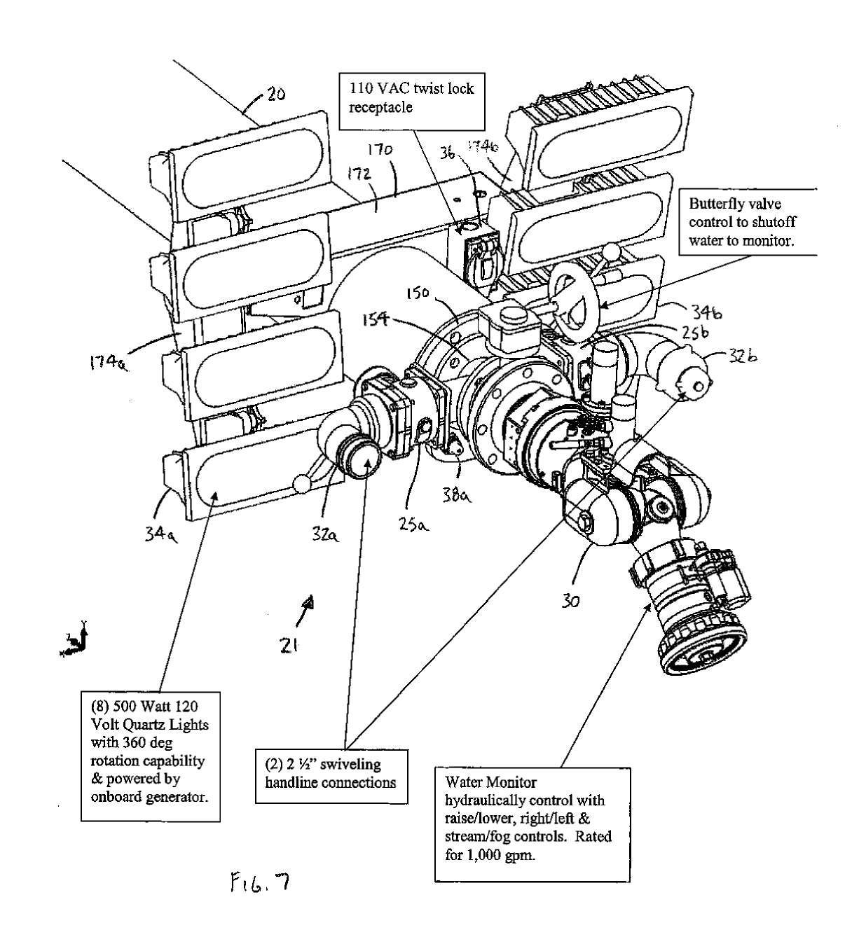

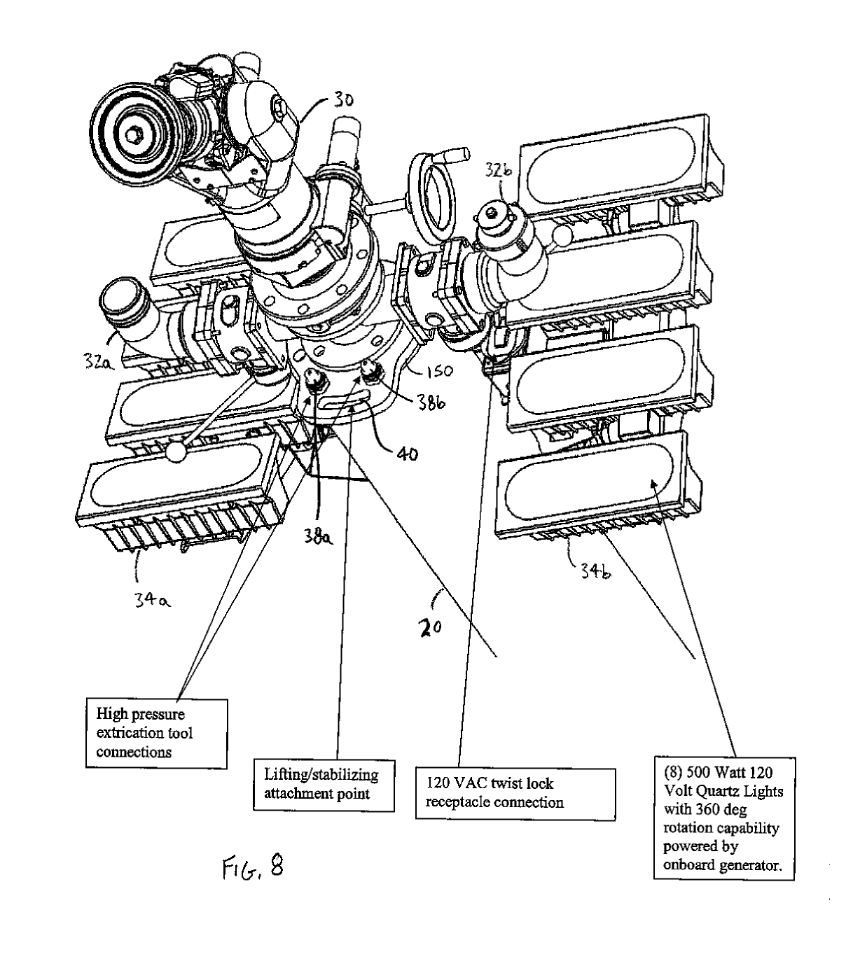

A fire engine 10 incorporating a boom in accordance with one embodiment of the present invention is shown in FIG. 1. The fire engine 10 (shown primarily in phantom lines) includes a boom 20 mounted to the fire engine 10 behind the cab 12. The boom 20 includes a workhead 21 carried on the free end of the boom 20 and a waterway 22 (See FIG. 6) for routing water from the fire engine 10 to the workhead 21. The boom also 20 also includes a plurality of channels 24a-d through which electrical cables 184 and 186, hydraulic hoses 180 and 188, networking cables 182 and other accessories may be routed and protected. In this embodiment, the boom 20 is a one-piece extrusion having a central waterway 22 (or water flow channel) disposed within an outer housing 26. The space between the outer housing 26 and the central waterway 22 is divided to define channels 24a-d. A plurality of fire and rescue accessories may be mounted to the workhead 21 of the boom 20. For example, the free end of the boom 20 may include a water monitor 30, one or more water handline connections 32a-b, one or more banks of lights 34a-b, an electrical receptacle 36, hydraulic supply fittings 38a-b and a lifting/stabilizing point 40.

As noted above, the present invention is described in connection with a water pumper engine capable of supplying water to the boom 20 using a water pump 14 located onboard the vehicle 10. The illustrated fire engine 10 includes an onboard water tank 15, which in this embodiment may hold approximately 500 gallons of water. The volume of the onboard tank 15 may vary. The present invention may be incorporated into other fire and rescue vehicles (or apparatus), including vehicles that do not include an onboard water supply or an onboard water pump. The fire engine 10 may also include an onboard generator 16 capable of providing electrical power for use by a variety of electrically powered accessories, such as the lights located on the boom 20. In the illustrated embodiment, the generator 16 is a 10 KW generator that is driven by power take off (PTO) operatively connected to the vehicle's transmission. Generator 16 may be replaced by a generator with an alternative power source or the boom 20 may obtain electrical power from an external power supply. The fire engine 10 may also include a hydraulic pump 18 to provide power for a variety of hydraulically power accessories, such as the boom drive assembly and the water monitor. The hydraulic pump 18 may be driven by a PTO operatively connected to the vehicles transmission. The fire engine 10 may also include conventional outriggers configured to provide the appropriate degree of lateral support. The outriggers may be hydraulically operated. Although described in connection with a specific fire engine, the present invention is well-suited for use with a wide range of fire and rescue apparatus. The fire engine 10 includes a superstructure configured to provide a mounting point for the boom 20 just behind the cab 12. The boom 20 may be mounted at alternative locations on the vehicle 10. For example, the boom 20 may alternatively be mounted at the rear of the vehicle 10 extending forwardly when in the stored position.

The boom 20 of the illustrated embodiment generally includes a waterway 22 enclosed within a plurality of channels 24a-d (See FIG. 6). The waterway 22 and channels 24a-d are configured to route water, power and other accessories to the free or operating end of the boom 20. Referring now to FIG. 6, the illustrated boom 20 includes a pair of concentric, circular walls 60 and 62 that are interconnected by a plurality of webs 64a-d. The inner wall 60 defines a central channel that functions as waterway 22 (or water flow channel). The inner wall 60 happens to be circular in this embodiment, but its size and shape may vary from application to application. In this embodiment, the outer wall 62 is spaced from the inner wall 60 to define an interior space 66. In the illustrated embodiment, the outer wall 62 is concentric with the inner wall 60 so the size and shape of the interior space 66 is largely uniform. This is not, however, necessary and the configuration of the interior space 66 may vary as desired. The webs 64a-d interconnect the inner wall 60 and the outer wall 62 while at the same time dividing the interior space 66 into channels 24a-d. In this embodiment, the boom 20 includes four webs 64a-d disposed in a radially symmetric arrangement that divides the interior space 66 into four channels 24a-d of approximately the same size and shape. The size, shape and number of webs may vary from application to application to provide alternative channel arrangements. For example, additional webs may be included to provide additional channels. As another example, the positions of the webs may be varied to provide channels of different sizes and shapes. In the illustrated embodiment, the webs 64a-d are generally continuous, thereby providing a high degree of isolation between the channels 24a-d, which may help to isolate problems within a particular channel 24a-d.

In this embodiment, the outer wall 60 not only provides the boom 20 with raceways to contain and protect various accessories routed through the channel 24a-d, but it also provides a protective shield around the waterway 22. It is not, however, necessary for the waterway 22 to be fully enclosed within an outer wall 62 as shown in the illustrated embodiment. Although the waterway 22 and channels 24a-d of the illustrated boom 20 are arranged in a concentric configuration, the waterway and channels may be implemented in other configurations. For example, the waterway and the channels may be in stacked or side-by-side arrangements.

In the illustrated embodiment, the boom 20 is manufactured from a single extrusion in which the inner wall 60, the outer wall 62 and the webs 64a-d are integrally formed. The illustrated boom 20 is approximately 25 feet in length, but the length of the boom 20 may vary from application to application, for example, to correspond with the length of the vehicle on which it is mounted.

As described in more detail below, the boom 20 may be mounted to the vehicle 10 on a pedestal 80 that permits the boom 20 to be rotated 360 degrees continuously with respect to the vehicle 10. To provide an interface with the pedestal 80 that permits the boom 20 to be tilted with respect to the vehicle 10, an inner clevis 70 may be mounted to the base of the boom 20. The inner clevis 70 may be welded or otherwise secured to the base of the boom 20. The boom 20 may include bracing to reinforce the interconnection between the inner clevis 70 and the boom 20. For example, as shown in FIG. 6, a brace 72 shaped to wrap around one side of the boom 20 may be welded to the boom 20 and the inner clevis 70. If desired, the inner clevis 70 may include additional structural elements, such as supports 74. In the illustrated embodiment, the inner clevis 70 defines a waterway opening 75 configured to permit connection of the water supply to the waterway 22, for example, through a heel pin waterway swivel 23 or other similar mechanism that provides translation during elevational movement of the boom 20. The inner clevis 70 may include a shallow boss 150 surrounding the waterway opening 75. The heel pin waterway swivel 23 may be welded directly to the boss 150. The inner clevis 70 may also include a plurality of additional openings 76 that permit wiring, hoses and other accessories to be routed into the boom 20. In the illustrated embodiment, the boom 20 is offset from the center of the inner clevis 70. Although not necessary, this offset arrangement provides improved vehicle packaging for many firefighting applications. Among other things, the offset arrangement accommodates the heel pin waterway swivel 23 and permits a side-by-side arrangement between the boom 20 and the elevation cylinder 90 (described in more detail below).

As noted above, the boom 20 is provided with both rotational and elevational movement. In the illustrated embodiment, the boom 20 is mounted to the vehicle 10 upon a rotation pedestal 80 that provides rotational movement of the boom 20. The pedestal 80 generally includes a stationary base 82 and a rotating head 84. The base 82 is mounted to the vehicle 10, for example, by welding, bolts or other fasteners. The head 84 includes a rotation bearing (not shown) and is rotatably mounted to the base 82 for 360 degree continuous rotation. As shown, this embodiment includes a drive motor 86 to provide rotational movement of the head 84 with respect to the pedestal 82. The drive motor 86 may be a conventional hydraulically driven worm gear that mates with the rotation bearing or with a separate spur gear. An outer clevis 71 may be mounted atop the head 84 to pivotally receive the boom 20. More specifically, the inner clevis 70 may be fitted into and rotatably coupled with the outer clevis 71. Although illustrated in connection with a specific pedestal construction, the invention may include any of a wide variety of turntable and other structural rotation components.

In this embodiment, a swivel 50 is contained within the pedestal 80 to provide fluid and electric transition between the vehicle and the moving boom 20. Suitable pre-manufactured fire apparatus swivels are available from Hydromotion Inc. of Spring City, Pa. Accordingly, the swivel 50 will not be described in this application in detail. Suffice it to say that the swivel 50 includes a variety of structures to pass water, electrical service and hydraulic fluid through the swivel 50 while permitting unfettered continuous rotation of the boom 20. A waterway inlet 51 may be fitted to the swivel 50 for connecting the swivel 50 to the water pump 14.

To provide adjustment of the elevation of the boom 20, an elevation cylinder 90 may be mounted between the pedestal 80 and the boom 20. In this embodiment, the elevation cylinder 90 may be a conventional hydraulic cylinder having a cylinder body 92 pivotally mounted to the pedestal 80 at flange 94 and a rod 96 pivotally mounted to the boom 20 at bracket 98. In the illustrated embodiment, the elevation cylinder 90 provides the boom 22 with a range of motion between −5 and 90 degrees. The range of motion may vary from application to application as desired. The elevation cylinder 90 may be replaced by essentially any mechanism capable of providing the boom 20 with the desired range of motion.

A valve bank 130 may be mounted to the head 84 of the pedestal 80. The valve bank 130 may include a plurality of conventional hydraulic valves capable of providing control over operation of the hydraulically operated components of the boom 20, including, for example, rotation of the boom 20, elevation of the boom 20 and all functions of the water monitor 30. The valve bank 130 will typically be located in a position where it is readily accessible to an operator.

As noted above, a variety of components are mounted to the workhead 21 of the illustrated boom 20. In the illustrated embodiment, a water monitor 30, a pair of water handline connections 32a-b, two banks of lights 34a-b, an electrical receptacle 36, a pair of hydraulic supply fittings 38a-b and a lifting/stabilizing point 40 are disposed at the working end of the boom 20. Additional accessories may be mounted to the boom 20, if desired. For example, the workhead 21 may include supply fittings (not shown) for pneumatic tools. The pneumatic supply fittings may provide pneumatic service for a host of pneumatic fire and rescue tools. Any service lines required to power additional accessories, such as pneumatic hoses, may be routed through a channel 24a-d in the boom 20. If desired, the interior space 66 may be divided into a greater or fewer number of channels. The free end of the illustrated boom 20 is closed by a flange 150. The flange 150 is a generally disc-shaped flange having an outer diameter that largely corresponds with the outer diameter of the boom 20. The flange 150 may be welded or otherwise secured to the end of the boom 20. The flange 150 defines a central waterflow opening (not visible) that is in fluid communication with the waterway 22 within the boom 20. A weldment 154 may be mounted to the flange 150 to provide structure for mounting the water monitor 30 and the two water handline connections 23a-b. The illustrated handline connections 23a-b are generally conventional 2½″ swiveling connections. Swiveling handline connections suitable for use with the present invention are available from a variety of well known suppliers. In this embodiment, the handline connections 23a-b are mounted to generally conventional manually operated control valves 25a-b.

In the illustrated embodiment, the water monitor 30 is a generally conventional hydraulically controlled water monitor with raise/lower, right/left and stream/fog controls. A variety of conventional water monitors suitable for use with the present invention are available from, among others, Akron Brass Company of Wooster, Ohio and Elkhart Brass Mfg. Col, Inc. of Elkhart, Ind. The illustrated water monitor 30 is rated for 1,000 gallons per minute; however, water monitors of different ratings may be used. The water monitor 30 of this embodiment is mounted to the weldment 150 on a conventional butterfly control valve 152. The butterfly control valve 152 may be used to shutoff water to the water monitor 30 to enable use of the handlines. In this embodiment, the hydraulic hoses 180 required to operate the water monitor 30 are routed through channel 24b. For simplicity, the hoses 180 at the workhead 21 are not shown in the figures. The hoses may emerge from the boom 20 through apertures (not shown) or fittings (not shown) in flange 150. Alternatively, the hoses 180 may emerge through one or more apertures through the outer wall 62 of the boom 20. As noted above, the water monitor 30 may be controlled by operation of a plurality of valves located in valve bank 130. The valves may be manually operated or computer controlled, as desired. Alternatively (or in addition), the water monitor 30 may be operated by a minicontroller and an arrangement of electromechanical valves located at the free end of the boom 20. In this embodiment, the minicontroller may receive power from 12 VDC power lines 186 routed through channel 24a and control signals via the CAN-Bus twisted pair cable 182 routed through channel 24d. This embodiment is well-sited for use with remote operation via wireless control. During remote operation, control signals received from the wireless control can be received at the vehicle 10 and relayed to the minicontroller (not controller) via the CAN-Bus twisted pair cable using conventional techniques and apparatus.

The flange 150 may also seat hydraulic supply fittings 38a-b. In this embodiment, hydraulic supply and return hoses routed through a channel 24a in the boom 20 are connected to the rear of each fitting 38a-b. To facilitate installation, maintenance and removal, the supply fittings 38a-b may be positioned on the flange 150 in alignment with the channel 24a containing the hydraulic supply hoses. These fittings 38a-b may be used to operate essentially any hydraulically powered equipment, such as high pressure extrication tools (not shown).

The flange 150 may be shaped to define a loop 156, hook or other extension that may be used as a lifting/stabilizing attachment point. The lifting/stabilizing point need not be integrated into the flange 150, and may alternatively be a separate component mounted either directly or indirectly to the boom 20.

As noted above, the boom 20 workhead may include one or more lights. In the illustrated embodiment, two banks of lights 34a-b are mounted to the boom 20 by a framework 170. The illustrated framework 170 generally includes a cross member 172 and a pair of support arms 174a-b. The cross member 172 may be welded or otherwise secured to the boom 20. A support arm 174a-b is mounted to each end of the cross member 172—each to receive a separate bank of lights. The support arms 174a-b may be pivotally mounted to the cross member 172 so that the orientation of the lights may be varied. In the illustrated embodiment, four lights are mounted to each support arm 174a-b. Each light may be a conventional 500 watt, 120 volt, quartz light. The number, size, shape and arrangement of lights may vary from application to application as desired. The lighting assembly may include structure for providing powered movement operation of the lights. In the illustrated embodiment, each bank of lights 34a-b is capable of separate powered movement about a pivot point between its support arm 174a-b and the cross member 172. The support arms 174a-b may be operably connected to a motor for rotation. For example, each support arm 174a-b may be rotatably coupled to a separate hydraulic or electric motor (not shown) so that operation of a motor results in rotation of the corresponding. If 360 degree continuous rotation of the lights is desired, an electric swivel or other electric transition mechanism may be incorporated in the lighting system. Alternatively, linear actuators, such as hydraulic or pneumatic cylinders, may be used to rotate the light banks 34a-b. Operation of the lights may be controlled manually or automatically. Manual controls for the light, including power and rotation, may be located near valve bank 130 or at other convenient locations. Alternatively (or in addition), controls for the light may be incorporated into a remote control (not shown).

To provide clean packaging, the power cables and the CAN-Bus twisted pair cable can be routed through the wall of boom 20 into the framework 170. For example, an aperture (not shown) may be defined through the wall of the boom 20 at a location hidden beneath the framework 170. The desired cables may be fed through the aperture and routed through the framework 170 to the final destination.

In this embodiment, the lights are turned “on” and “off” using a microcontroller (not shown) disposed on the boom workhead 21. The microcontroller controls operation of the lights in response to control signals received via the CAN-Bus twisted pair cable. The microcontroller may also be used to control rotational movement of the lights. The lights may alternative be operated using manual controls, such as conventional analog switching components, or using other automated control systems.

The boom workhead 21 may also include one or more power receptacles. In the illustrated embodiment, the workhead includes a single 110 VAC twist-lock receptacle. The boom 20 workhead may be provided with additional 110 VAC receptacles and/or receptacle(s) for other forms of electrical power. For example, 220 VAC and/or 12 VDC power cables may be routed through the boom 20 and made accessible at a receptacle on the workhead 21. Power receptacles may be mounted at essentially any location on the workhead 21.

Although not illustrated, the boom 20 may also include a winch (not shown). The winch may be mounted to the boom 20 or it may be mounted to the head 84 of the pedestal 80 and include a cable that extends through a pulley or guide (not shown) disposed at the free end of the boom 20. For example, block and tackle (not shown) may be suspended from hook 156, and the winch may include cables that run through the block and tackle. The boom 20 may incorporate virtually any winch capable of handling the desired loads, such as a conventional electric winch or a conventional hydraulic winch.

If desired, the boom 22 may incorporate communications equipment, including communications equipment capable of providing real-time command and control at a fire or rescue scene. For example, the boom 22 may include antennae, network relays, wireless routers, communications relays, transceivers and other communications equipment (not shown) for a wide variety of communications systems, such as ground-based satellite communications, trunk radio, base stations and various forms of local network communications. These systems may provide secure and non-secure voice, data and video communications and transmission. The workhead 21 may further include automation equipment capable of moving directional antennae and satellite transceivers, such as electric motors or various types of linear actuators. All power and communications cables associated with the communications equipment may be routed through one or more channels 24a-d in the boom 22.

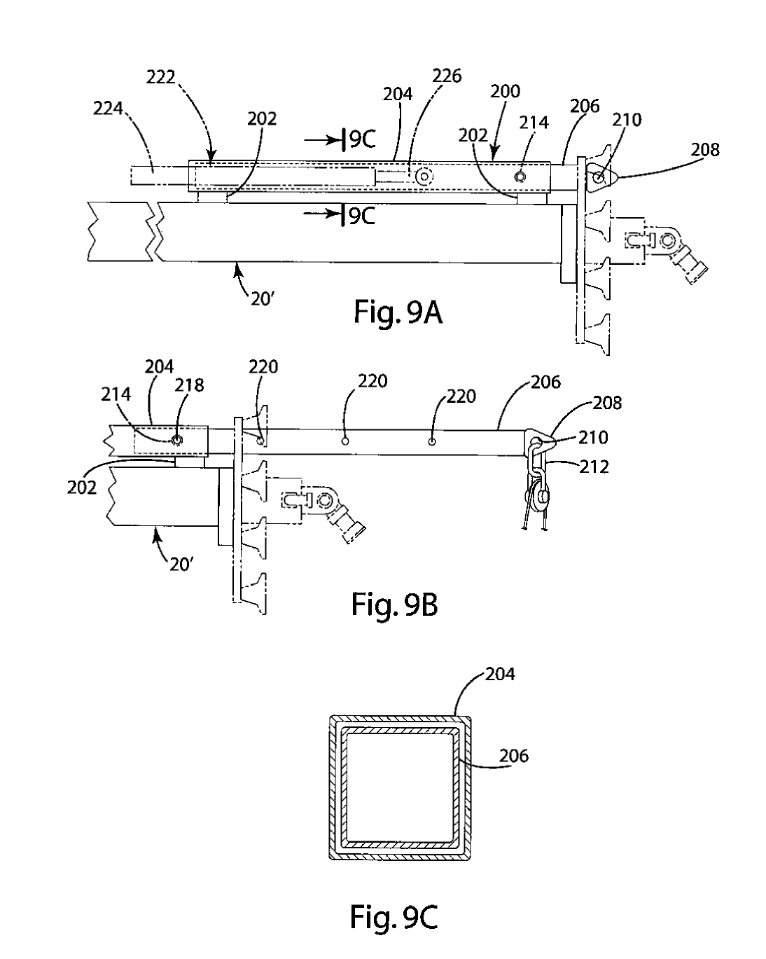

In an alternative embodiment, the boom 20′ may also include an extendible lift arm assembly 200 (See FIGS. 9A-C). The lift arm assembly 200 is mounted at the working end of the boom to provide an extendible structure capable of extending the reach of the boom. For example, the extendible lift arm assembly 200 may be welded to the upper surface of the boom, such as by brackets 202. The lift arm assembly 200 may be mounted to the boom in alternative locations and may be secured using alternative securing structures, such as bolts or clamps.

In the embodiment of FIGS. 9A-C, the lift arm assembly 200 is a telescopic structure having a boom extension housing 204 and an extendible boom arm 206. As shown in FIG. 9C, the boom extension housing 204 and extendible boom arm 206 may be generally rectangular in cross section. However, the cross sectional shape of these components may vary from application to application. The boom extension housing 204 and extendible boom arm 206 may be manufactured using conventional techniques and apparatus. For example, each component may be manufactured from an appropriate aluminum extrusion. Although shown as a telescopic construction, the lift arm assembly 200 may be of an alternative extendible construction.

Bushings, bearings, rollers or friction pads (not shown) may be disposed between the boom extension housing 204 and the extendible boom arm 206 to shepherd the extendible boom arm 206 during motion. The bushings, bearings, rollers or pads may be disposed on all sides of the boom arm 206 or only on select sides depending on the application. For example, Nylatron or other nylon low friction pads may be positioned between the boom arm 206 and the outer housing 206 on the top, bottom and both sides. The pads may be positioned at locations selected to ensure that the boom arm 206 rides along low friction pads throughout its entire range of motion.

The free end of the boom arm 206 may terminate in a lifting head 208. The lifting head 208 may define an eye 210 for receiving a clevis 212. In the illustrated embodiment, the lifting head 208 is welded or otherwise secured to the end of the boom arm 206. The illustrated lifting head 208 and clevis 212 provide a structure for suspending a lifting connection, such as a pulley, from the boom arm 206. In an alternative embodiment, the boom arm 206 may terminate in a tool or working structure other than a lifting head 208.

In the illustrated embodiment, the lift arm assembly 200 is manually extended and retracted, and it includes a locking mechanism for securing the boom arm 206 in the desired position with respect to the extension housing 204. As shown, the locking mechanism may include a locking pin 214 (shown in phantom lines in FIGS. 9A and 9B) and an arrangement of holes 218, 220 in the extension housing 204 and the boom arm 206. In use, the boom arm 206 is positioned so that one of the boom arm holes 220 is aligned with the extension housing hole 218 and then the locking pin 214 is installed through the holes 218, 220 to lock the boom arm 206 in place.

Alternatively, the boom arm 206 may be extended and retracted using hydraulic, pneumatic or other fluid power. A hydraulic, pneumatic or other fluid power cylinder may be coupled between the outer housing 204 and the boom arm 206 such that extension and retraction of the cylinder results in corresponding movement of the boom arm 206. An exemplary hydraulic cylinder 222 is shown in phantom lines in FIG. 9A. As shown, the hydraulic cylinder 222 may be positioned within the lift arm assembly 200. The piston cylinder 224 may be connected to the outer housing 204, for example, by a suitable bracket, and the piston rod 226 may be operatively connected to the boot arm 206, again potentially by a suitable bracket. In applications that incorporate a hydraulic or pneumatic drive system, the lift arm assembly 200 may not require a locking mechanism. Rather, the hydraulic or pneumatic cylinder may itself hold the boom arm 206 in the desired position.

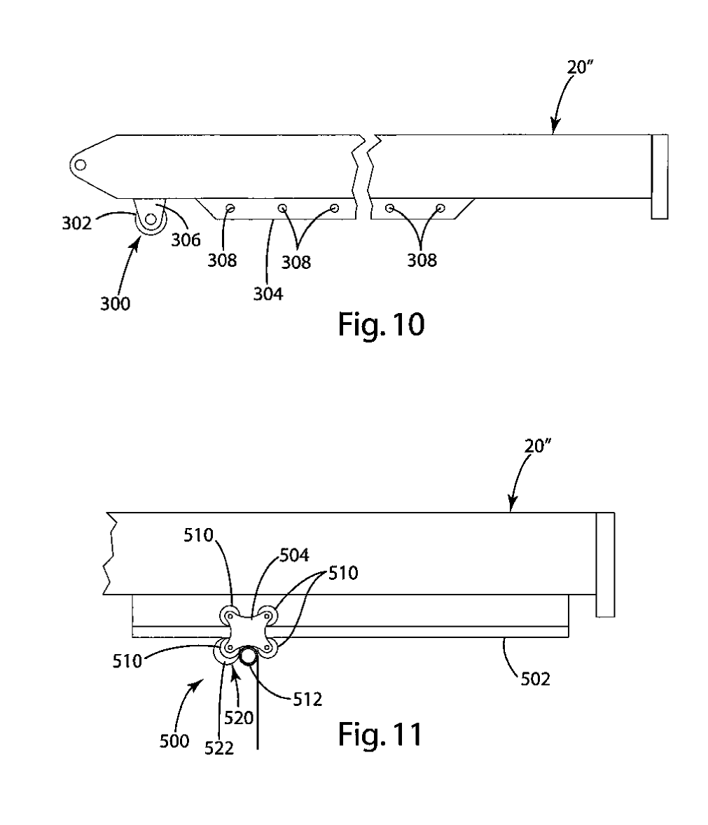

As shown in FIG. 10, the boom 20″ may also include an intermediate lifting system 300 that can be use to assist in lifting fire and rescue equipment from the top of the truck to the ground and vice versa. The illustrated intermediate lifting system 300 generally includes a winch 302 and a lift beam 304. The winch 302 may be an electric winch, a hydraulic winch or essentially any type of winch suitable for lifting the anticipated loads. The winch 302 is mounted to the undersurface of the boom 20″, for example, by a winch bracket 306. The winch 302 may be mounted toward the pivoting end of the boom 20″, as shown in the illustrations. The winch bracket 306 may be welded, bolted or otherwise secured to the boom 20″. If desired, the winch 302 may be replaced by other manual or powered lifting devices.

Like the winch 302, the illustrated lift beam 304 is mounted to the undersurface of the boom 20″, for example, by welding, bolts or other mechanisms. The lift beam 304 defines a plurality of holes 308 that function as spaced lift points. A clevis (not shown) may be used to secure a lifting connection, such as a pulley, from any one of the lift points 308. The lift point 308 may be selected to provide a lifting location as close to directly above the item to be lifted as possible. The size, shape, configuration and spacing of the lift points 308 may vary from application to application. The lift beam 304 may be replaced by other components capable of providing lift points for the intermediate lifting system. For example, the continuous lift beam 304 may be replaced by a plurality of separate lift beam segments (not shown). In this alternative, each lift beam segment may define one or more lift points. As another example, it may be possible in some applications to form the lift points directly in the boom, thereby eliminating the need for manufacture and installation of a separate lift beam.

Although the illustrated winch 302 and lift beam 304 are mounted along the undersurface of the boom 20″, they may be mounted in alternative locations, such as along either side of the boom 20″.

In another alternative embodiment, the intermediate lifting system 400 includes a track and trolley system 500 that provides a movable lift point (See FIG. 11). The track and trolley system 500 may include a track 502 mounted along a portion of the length of the boom 20″ and a trolley 504 that rides along the track 502. The track 502 may include a beam 506 that is welded or otherwise secured to the undersurface of the boom 20″. The beam 506 may be an I-beam or have essentially any cross sectional shape suitable to support a trolley 504. The length of the track 502 may vary depending on the application. However, it will typically be desirable to provide the track 502 with the maximum possible length to provide the track and trolley system 500 with the broadest range of motion. The trolley 504 may includes a plurality of rollers 510 that entrap and ride along the track 502 in a conventional manner. If desired, the trolley 504 may carry a winch 512 or other lifting device. Alternatively, an external winch (not shown) or other lifting device may be used in combination with a lifting connection mounted to the trolley 504. For example, a winch (not shown) may be mounted to the boom 20″ and may include a rope or cable that passes through a pulley suspended from the trolley 504.

The track and trolley system 500 may include a drive mechanism 520 for moving the trolley 504 along the track 502. Although the present invention may include essentially any trolley drive mechanism, the illustrated embodiment includes an electric drive motor 522 and drive wheel 524 that move the trolley 504 along the track 502. In this embodiment, forward and rearward operation of drive motor 522 results in forward and rearward rotation of drive wheel 524, which, in turn, causes forward and rearward movement of the trolley 504 along the track 502. As an example of an alternative drive mechanism, the electric drive motor 522 and drive wheel 524 may be replaced by a cable drive system (not shown), which has a drive motor mounted at a fixed location off of the trolley, for example, on the boom 20″. Drive cables extend from the drive motor through a series of pulleys to the trolley such that operation of the drive motor results in movement of the trolley 504 along the track 502. Track and trolley systems with cable drive systems are often used on cranes. Essentially any cable drive system used with crane may be adapted for use in the track and trolley system 500 of the present invention.

The above description is that of a current embodiment of the invention. Various alterations and changes can be made without departing from the spirit and broader aspects of the invention as defined in the appended claims, which are to be interpreted in accordance with the principles of patent law including the doctrine of equivalents. Any reference to a claim element in the singular, for example, using the articles “a,” “an,” “the” or “said,” is not to be construed as limiting the element to the singular.

1. A boom adapted for use on a fire fighting/rescue vehicle comprising:
an elongated outer housing;
an inner body, forming an enclosed channel for water flow, contained within said outer housing; and
a plurality of connecting fins connecting an interior of said outer housing with an exterior of said inner body; said outer housing and said inner body defining, said space being divided by said fins into generally independent channels within which elongated electrical control line members and hydraulic lines can be contained and protected.

2. A boom according to claim 1 wherein said housing, said inner body and said fins are all formed by a one piece extruded structure.

3. A boom according to claim 1 wherein said inner body is generally cylindrical in shape and is fixed at a center of said outer housing and wherein said fins extend radially from said inner body.

4. A boom according to claim 1 further including a workhead mounted to said boom; and
wherein said workhead includes a water monitor.

5. A boom according to claim 7 wherein said workhead includes a light.

6. A boom according to claim 8 wherein said workhead includes at least one of a water handline connection and a lifting/stabilizing point.

7. A boom according to claim 10 wherein said workhead includes at least one of an electrical receptacle and a hydraulic fitting.

8. In combination, a fire fighting engine having a boom according to claim 7 pivotally attached to said engine.

9. The boom of claim 1 further including an extendible lift arm assembly mounted to said boom.

10. The boom of claim 9 wherein said lift arm assembly includes an outer housing and a lift arm telescopically disposed within said outer housing; and
wherein said lift arm assembly includes a lift head mounted to said lift arm, said lift head defining a lift point.

11. The boom of claim 1 further including an intermediate lifting system.

12. The boom of claim 11 wherein said intermediate lifting system includes a lift beam mounted to said boom, said lift beam defining one or more lift points.

13. The boom of claim 11 wherein said intermediate lifting system includes a track and trolley system; and
wherein said trolley includes a lift point.

14. A fire or rescue vehicle comprising:
an elongated boom having first and second ends, said boom movably mounted to the vehicle at said first end, said boom having an outer wall and an inner wall, said inner wall defining a waterway, said outer wall and said inner wall cooperatively defining at least one channel independent from said waterway; and
a workhead mounted at said second end of said boom, said workhead including a water monitor.

15. The vehicle of claim 14 wherein said outer wall and said inner wall are coaxial, said channel being further defined as a space between said outer wall and said inner wall; and
further including a plurality of divider walls interconnecting said outer wall and said inner wall, said walls dividing said space into at least two generally independent channels.

16. The vehicle of claim 15 wherein said outer wall, said inner wall and said divider walls are integrally formed as a one-piece extruded structure.

17. The vehicle of claim 16 wherein said workhead includes at least one of a light, a water handline connection, a lifting/stabilizing point, an electrical receptacle, a pneumatic fitting, and a hydraulic fitting.

18. The vehicle of claim 16 wherein said workhead includes a light, an electrical receptacle and a fluid power fitting.

19. The vehicle of claim 14 further including an extendible lift arm assembly mounted to said boom, said lift arm assembly being selectively extendible beyond said boom.

20. The vehicle of claim 14 further including an intermediate lifting system defining a plurality of lift points along a length of said boom.

21. The vehicle of claim 14 further including an intermediate lifting system having a track and trolley system mounted along a length of said boom, said trolley defining a lift point.

22. A fire and rescue boom comprising:
a one-piece extruded structure having:
an elongated outer housing with a diameter;
an inner housing defining a waterway, said inner housing disposed within said outer housing having a diameter substantially smaller than said diameter of said outer housing, whereby a space is defined between said outer housing and said inner housing; and
a plurality of radial walls interconnecting said outer housing and said inner housing, said radial walls dividing said space into a plurality of channels; and
a workhead connected to an end of said boom, said workhead including a water monitor, said water monitor being operatively connected with said waterway, whereby said water monitor receives water via said waterway, said workhead further including an electrical component, said electrical component being supplied electrical power via electrical supply lines routed through one of said plurality of channels, said workhead further including a fluid power supply fitting, said fluid power supply fitting receiving fluid power via fluid a power supply line routed through one of said plurality of channels.

23. The boom of claim 22 wherein said electrical component is at least one of an electrical receptacle or a light.

24. The boom of claim 22 further including an extendible lift arm assembly mounted to said boom, said lift arm assembly including an extendible boom arm terminating in a lift point, said extendible boom arm selectively extendible beyond said workhead.

25. The boom of claim 22 further including an intermediate lifting assembly mounted to said boom and providing a lift point at a location along a length of said boom.
